(19) United States
(12) Patent Application Publication
(10) Pub. No.: US 2020/0061923 A1
(43) Pub. Date: Feb. 27, 2020

(54) THREE DIMENSIONAL PRINTING METHOD AND THREE DIMENSIONAL PRINTING APPARATUS

(71) Applicants: XYZprinting, Inc., New Taipei City (TW); Kinpo Electronics, Inc., New Taipei City (TW)

(72) Inventor: Shau-An Tsai, New Taipei City (TW)

(73) Assignees: XYZprinting, Inc., New Taipei City (TW); Kinpo Electronics, Inc., New Taipei City (TW)

(21) Appl. No.: 16/186,596

(22) Filed: Nov. 12, 2018

(30) Foreign Application Priority Data
Aug. 24, 2018 (CN) 201810971477.2

(51) Int. Cl. B29C 64/393; B33Y 10/00; B33Y 30/00; B33Y 50/02

(52) U.S. Cl. CPC B29C 64/393; B33Y 10/00; B29C 64/10; B33Y 50/02; B33Y 30/00

(57) ABSTRACT

A three-dimensional (3D) printing method and a 3D printing apparatus are provided. The 3D printing method includes: acquiring a plurality of slice information corresponding to a plurality of sliced objects of a 3D model; obtaining a contour pattern corresponding to one of the sliced objects according to the slice information; determining a plurality of reference points located in the contour pattern; determining a location of at least one support point on the sliced object according to the reference points located in the contour pattern; printing at least one support element connected to the at least one support point on a platform according to the location of the at least one support point, so that the 3D model is supported by the at least one support element and fixed to the platform.

### CROSS-REFERENCE TO RELATED APPLICATION

This application claims the priority benefit of China application serial no. 201810971477.2, filed on Aug. 24, 2018. The entirety of the above-mentioned patent application is hereby incorporated by reference herein and made a part of this specification.

### BACKGROUND

### Technical Field

The disclosure relates to a three-dimensional (3D) printing method and a 3D printing apparatus.

### Description of Related Art

With the advancement of computer-aided manufacturing (CAM), the manufacturing industry has developed a three-dimensional (3D) printing technology that can quickly reduce the original design concept to practice. The 3D printing technology is in fact a general name for a series of rapid prototyping (RP) technologies, and a basic principle of these RP technologies is additive manufacturing, i.e., an RP machine generates a sectional shape of an object in an X-Y plane through scanning, and intermittently performs displacement by the thickness of layer along Z coordinates, so as to form a 3D object. Geometric shape is not a limitation when the 3D printing technology is applied, and the more complex the parts are, the more excellent the RP technology is, and the greater the manpower and processing time are reduced.

Since the 3D printing technology is additive manufacturing, if the 3D model has a plurality of protruding portions, an overhanging portion which is apparent and not supported may be produced on the platform of the 3D printing device. As a result, when the overhanging portion is being printed, the overhanging portion may collapse, and the printing action may then fail.

### SUMMARY

The disclosure provides a three-dimensional (3D) printing method and a 3D printing apparatus configured to print a 3D model with an overhanging region.

In an embodiment provided in the disclosure, a 3D printing method suitable for a 3D printing apparatus is provided. The 3D printing apparatus is configured to print a 3D model on a platform. The 3D printing method includes: acquiring a plurality of slice information corresponding to a plurality of sliced objects of a 3D model, wherein a direction of a normal vector of each of the sliced objects is the same as a direction of a normal vector of the platform, the sliced objects include a first sliced object, and the slice information includes first slice information corresponding to the first sliced object; acquiring a contour pattern corresponding to the first sliced object according to the first slice information; determining a plurality of reference points located in the contour pattern; determining a location of at least one support point on the first sliced object according to the reference points located in the contour pattern; printing at least one support element connected to the at least one support point on the platform according to the location of the at least one support point, so that the 3D model is supported by the at least one support element and fixed to the platform.

In an embodiment provided in the disclosure, a 3D printing apparatus includes a platform, a print head, and a processor. The print head is configured to print a 3D model on the platform. The processor is configured to acquire a plurality of slice information corresponding to a plurality of sliced objects of the 3D model, wherein a direction of a normal vector of each of the sliced objects is the same as a direction of a normal vector of the platform, the sliced objects include a first sliced object, and the slice information includes first slice information corresponding to the first sliced object. The processor is configured to acquire a contour pattern corresponding to the first sliced object according to the first slice information, determine a plurality of reference points located in the contour pattern, and determine a location of at least one support point on the first sliced object according to the reference points located in the contour pattern. The processor is further configured to control the print head to print at least one support element connected to the at least one support point on the platform according to the location of the at least one support point, so that the 3D model is supported by the at least one support element and fixed to the platform.

In view of the above, in one or more embodiments provided in the disclosure, the contour pattern corresponding to one of the sliced objects is acquired according to the slice information, the location of at least one support point on the sliced object is determined according to the reference points located in the contour pattern, and at least one support element connected to the at least one support point is printed on the platform according to the location of the at least one support point. Thereby, the overhanging portion of the 3D model may be supported by the at least one support element, so as to prevent the overhanging portion from collapsing.

To make the above features and advantages provided in one or more of the embodiments provided in the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1 is a schematic view illustrating a three-dimensional (3D) printing apparatus according to an embodiment provided in the disclosure.

FIG. 2 is a flowchart illustrating a 3D printing method according to an embodiment provided in the disclosure.

FIG. 3 is a flowchart illustrating a 3D printing method according to another embodiment provided in the disclosure.

FIG. 4A to FIG. 4D are schematic views of generating a support point according to an embodiment provided in the disclosure.

FIG. 5A to FIG. 5C are schematic views of generating a support point according to another embodiment provided in the disclosure.

FIG. 6 is a schematic view of generating a support point according to still another embodiment provided in the disclosure.

### DESCRIPTION OF THE EMBODIMENTS

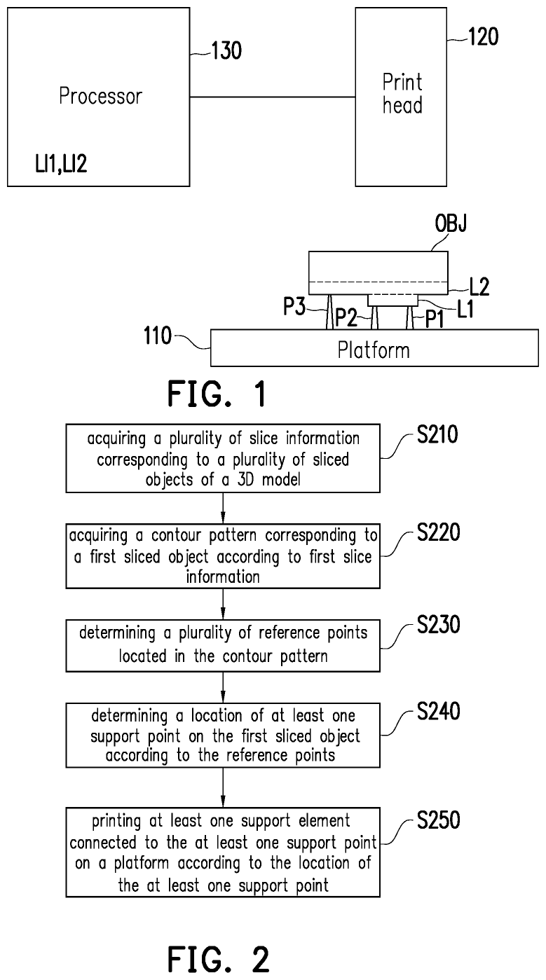

Please refer to FIG. 1, which is a schematic view illustrating a three-dimensional (3D) printing apparatus according to an embodiment provided in the disclosure. According to the present embodiment, the 3D printing apparatus includes a platform 110, a print head 120, and a processor 130. The print head 120 is configured to form a 3D model OBJ on the platform 110. The processor 130 is configured to acquire a plurality of slice information corresponding to a plurality of sliced objects of the 3D model OBJ, acquire a plurality of contour patterns according to the slice information, and print support elements P1-P3 according to a plurality of reference points located in the contour patterns. For instance, the processor 130 may at least acquire first slice information LI1 of a first sliced object L1 and second slice information LI2 of a second sliced object L2 of the 3D model OBJ. The processor 130 prints support elements P1-P3 according to the first slice information LI1 and the second slice information LI2. The processor 130 provided in the present embodiment may be, for instance, a central processing unit (CPU), a programmable general-purpose or special-purpose microprocessor, a digital signal processor (DSP), a programmable controller, an application specific integrated circuit (ASIC), a programmable logic device (PLD), any other similar device, or a combination of said devices, and may be loaded to perform computer programs.

Specifically, please refer to FIG. 1 and FIG. 2. FIG. 2 is a flowchart illustrating a 3D printing method according to an embodiment provided in the disclosure. According to the present embodiment, the processor 130 acquires a plurality of slice information corresponding to a plurality of sliced objects of the 3D model OBJ in step S210. In step S210, the processor 130 divides the 3D model OBJ into a plurality of sliced objects and acquires a plurality of slice information corresponding to a plurality of sliced objects. For instance, the processor 130 may categorize the 3D model OBJ into a lowermost first sliced object and acquire the first slice information corresponding to the first sliced object, the second sliced object and acquire the second slice information corresponding to the second sliced object, and so on. In the sliced objects, a direction of a normal vector of each sliced object is the same as a direction of a normal vector of the platform 110. That is, the sliced objects are planar to a surface of the platform 110.

In step S220, the processor 130 acquires the contour pattern corresponding to the first sliced object L1 according to the first slice information LI1. Besides, the processor 130 determines a plurality of reference points of the contour pattern in step S230. In step S240, the processor 130 determines a location of at least one support point on the first sliced object L1 according to the reference points in the contour pattern.

After the location of the at least one support point is determined, the processor 130 in step S250 may control the print head 120 to print the support elements P1-P3 connected to the at least one support point on the platform 110 according to the location of the at least one support point. Thereby, the 3D model OBJ may be supported by the support elements P1-P3 and may be further fixed to the platform 110.

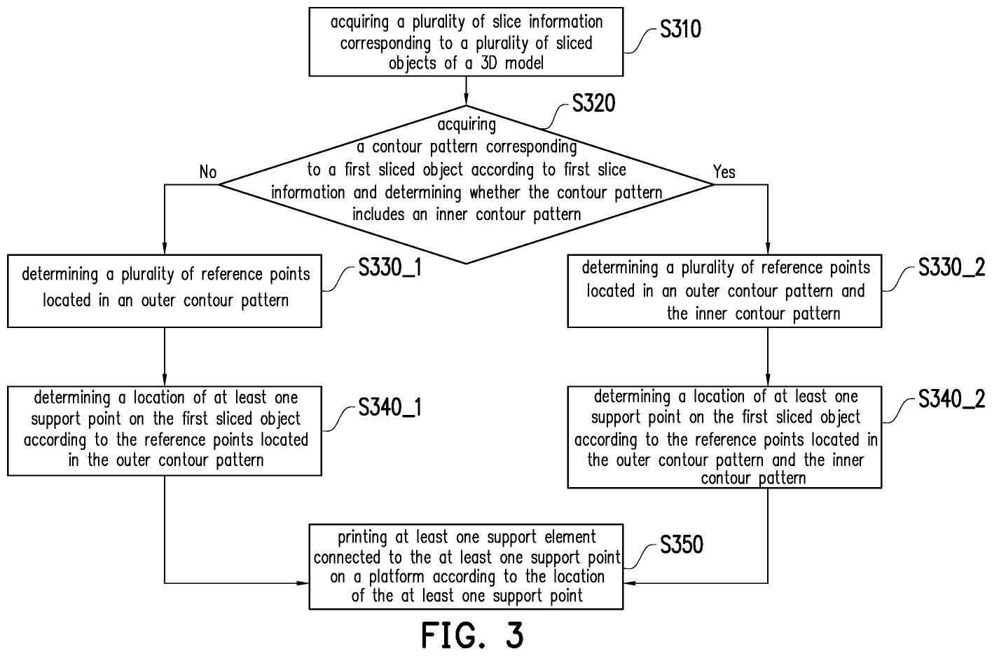

Please refer to FIG. 1 and FIG. 3. FIG. 3 is a flowchart illustrating a 3D printing method according to another embodiment provided in the disclosure. According to the present embodiment, the processor 130 in step S310 acquires a plurality of slice information corresponding to a plurality of sliced objects of the 3D model OBJ. The implementation details of the step S310 are the same as those in the step S210 and therefore will not be repeated hereinafter.

In step S320, the first sliced object L1 is taken as an example, and the processor 130 acquires the contour pattern corresponding to the first sliced object L1 according to the first slice information LI1. Besides, the processor 130 further determines whether the contour pattern corresponding to the first sliced object L1 not only includes an outer contour pattern but also includes an inner contour pattern. If the processor 130 determines that the first sliced object L1 does not include any inner contour pattern, it indicates that the first sliced object L1 is a sliced object not including a hollow region. In step S330_1, the processor 130 determines a plurality of first reference points of the outer contour pattern, and the processor 130 in step S340_1 determines the location of the at least one support point on the first sliced object L1 according to the first reference points of the outer contour pattern. As such, the at least one support point of the first sliced object L1 may be formed on end points of the first sliced object L1.

In some embodiments, the processor 130 may in step S330_1 further shrink the outer contour pattern to acquire a first contour pattern and determine at least one first reference point in the first contour pattern. The processor 130 may in step S340_1 determine a location of the at least one first support point on the first sliced object L1 according to the at least one first reference point located in the first contour pattern.

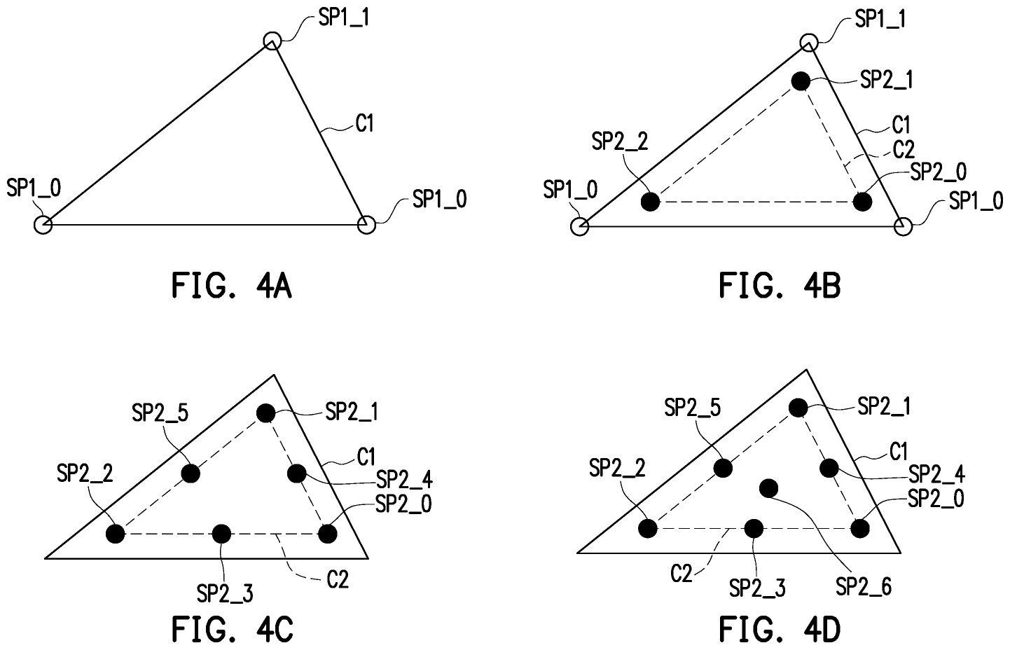

The implementation details of the steps S330_1 and S340_1 are elaborated hereinafter. Please refer to FIG. 1 and FIG. 4A to FIG. 4D. FIG. 4A to FIG. 4D are schematic views of generating a support point according to an embodiment provided in the disclosure. According to the present embodiment, in FIG. 4A, the processor 130 determines that the outer contour pattern C1 of the sliced object has three end points. The three end points of the outer contour pattern C1 may respectively serve as reference points SP1_0, SP1_1, and SP1_2.

As shown in FIG. 4B, the processor 130 shrinks the outer contour pattern C1 to form the first contour pattern C2. The three end points of the first contour pattern C2 may respectively serve as the first reference points SP2_0, SP2_1, and SP2_2. In addition, the processor 130 determines the location of the at least one support point on the first sliced object L1 according to the first reference points SP2_0, SP2_1, and SP2_2.

Note that the at least one support point is formed at the locations of the first reference points SP2_0, SP2_1, and SP2_2 but is not formed on the end points of the sliced object or on the edge thereof. Thereby, after the printing action is completed, and in case that no support element exists at the end points or on the edge of the 3D model, the end points or the edge of the 3D model is not damaged during the removal of the at least one support element, and therefore the 3D model is not easily damaged.

In FIG. 4B, the first reference point SP2_0 of the first contour pattern C2 corresponds to the reference point SP1_0 of the outer contour pattern C1. The first reference point SP2_1 of the first contour pattern C2 corresponds to the reference point SP1_1 of the outer contour pattern C1. The first reference point SP2_2 of the first contour pattern C2 corresponds to the reference point SP1_2 of the outer contour pattern C1. In some embodiments, the processor 130 may move the reference points SP1_0, SP1_1, and SP1_2 toward any point within the outer contour pattern C1 (e.g., the center of gravity of the outer contour pattern C1), so as to respectively form the first reference points SP2_0, SP2_1, and SP2_2, whereby the first contour pattern C2 is formed.

Next, in FIG. 4C, the first reference points SP2_0, SP2_1, and SP2_2 respectively replace the reference points SP1_0, SP1_1, and SP1_2. This causes the reference point of the first slice information L1 to include the first reference points SP2_0, SP2_1, and SP2_2. The processor 130 determines the location of the at least one first support point on the first sliced object L1 according to the first reference points SP2_0-SP2_2 located in the first contour pattern C2, and therefore the at least one support point of the first sliced object L1 includes the at least one first support point.

In FIG. 4C, the processor 130 determines whether a distance between the adjacent first support points (a first distance) is greater than a first predetermined distance. For instance, if the processor 130 determines the distance (the first distance) between the adjacent first reference points SP2_0 (the third reference point) and SP2_1 (the fourth reference point) is greater than the first predetermined distance, the processor 130 sets a reference point SP2_4 (the fifth reference point) between the first reference points SP2_0 (third reference point) and SP2_1 (fourth reference point). Thereby, the distance between the newly added reference point SP2_4 and the first reference point SP2_0 is less than the first predetermined distance, and the distance between the newly added reference point SP2_4 and the first reference point SP2_1 is less than the first predetermined distance. For instance, if the distance between the adjacent first reference points SP2_0 and SP2_1 is less than or equal to the first predetermined distance, no new reference point is set between the first reference points SP2_0 and SP2_1.

According to the present embodiment, the first predetermined distance is associated with a radius of a supportable range of the at least one support element. That is, the first predetermined distance may be equal to the radius of the supportable range of the at least one support element. Alternatively, the first predetermined distance may be 80% of, 50% of, twice the radius of the supportable range of the at least one support element (i.e., a diameter of the supportable range), or the like. The first predetermined distance may be adjusted according to design requirements. The supportable range of the supportable range is determined by a structure of the at least one support element and the printing material.

Hence, as shown in FIG. 4C, if the distance among the first reference points SP2_0, SP2_1, SP2_2 remains greater than the first predetermined distance, the processor 130 sets the at least one first support point at the reference points SP2_4, SP2_5, and SP2_6. Besides, in the present embodiment, the reference points SP2_4, SP2_5, and SP2_6 are located in the first contour pattern C2, which should not be construed as a limitation in the disclosure. In some embodiments, the reference point SP2_4, SP2_5, and SP2_6 may be located within the first contour pattern C2 or within the contour pattern C1.

In some embodiments, the offset distance between the reference points SP2_0 and SP1_0, the offset distance between the reference points SP2_1 and SP1_1, and the offset distance between the reference points SP2_2 and SP1_2 may be limited to be less than or equal to the first predetermined distance, so as to ensure that the at least one support element at the reference points SP2_0, SP2_1, and SP2_2 is able to effectively support the edge of the sliced object.

Next, in FIG. 4D, the processor 130 determines whether an area of a first region surrounded by the first contour pattern C1 in the first sliced object L1 is greater than a threshold area. If the processor 130 determines that the area of the first region is greater than the threshold area, the processor 130 determines a location of the newly added support point in the first region according to the supportable range of the at least one support element. The location of the newly added support point is evenly distributed in the first region. As shown in FIG. 4D, the processor 130 determines that the reference point SP2_6 is located at the newly added support point. Thereby, the at least one support point at the reference points SP2_1-SP2_6 can effectively support the sliced objects.

Please refer to the embodiments shown in FIG. 1 and FIG. 3. If the processor 130 in step S320 determines that the first sliced object L1 includes the outer contour pattern and the inner contour pattern, it indicates that the first sliced object L1 is a sliced object including at least one hollow region. In step S330_2, the processor 130 determines at least one first reference point of the outer contour pattern and a plurality of second reference points of the inner contour pattern. In step S340_2, the processor 130 determines the location of the at least one support point on the first sliced object L1 according to the at least one first reference point of the outer contour pattern and the second reference points of the inner contour pattern.

In some embodiments, the processor 130 may in step S330_2 further shrink the outer contour pattern to acquire a first contour pattern and determine at least one first reference point in the first contour pattern. The processor 130 may in step S330_2 also enlarge the inner contour pattern to acquire a second contour pattern and determine at least one second reference point in the second contour pattern. The processor 130 may in step S340_2 determine the location of the at least one first support point on the first sliced object L1 according to the at least one first reference point located in the first contour pattern. The processor 130 may in step S340_2 determine a location of the at least one second support point on the first sliced object L1 according to the at least one second reference point located in the second contour pattern.

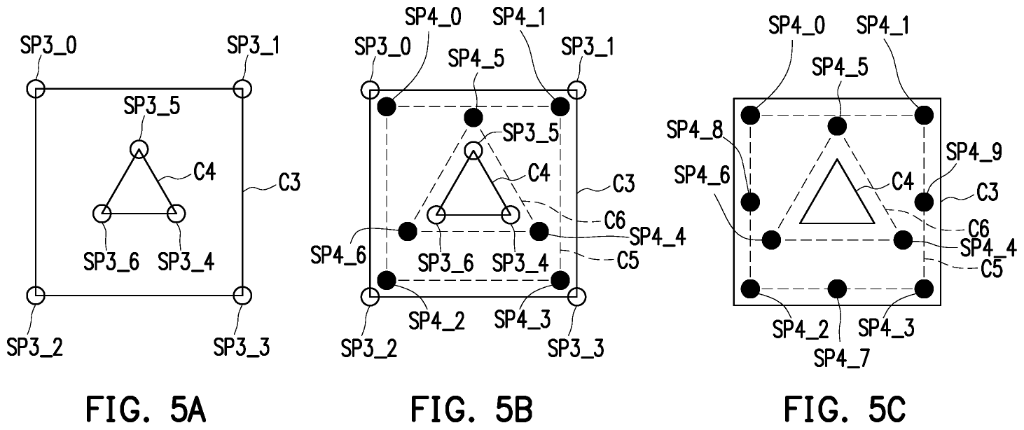

The implementation details of the steps S330_1 and S340_1 are elaborated hereinafter. Please refer to FIG. 1 and FIG. 5A to FIG. 5C. FIG. 5A to FIG. 5C are schematic views of generating a support point according to another embodiment provided in the disclosure. According to the present embodiment, in FIG. 5A, the processor 130 determines that the contour pattern of the sliced object includes an outer contour pattern C3 and an inner contour pattern C4. The outer contour pattern C3 has four end points. The four end points of the outer contour pattern C3 may respectively serve as reference points SP3_0, SP3_1, SP3_2, and SP3_3. The inner contour pattern C4 has three end points. The three end points of the inner contour pattern C4 may respectively serve as the reference points SP3_4, SP3_5, and SP3_6.

As shown in FIG. 5B, the processor 130 shrinks the outer contour pattern C3 to form the first contour pattern C4. The four end points of the first contour pattern C4 may respectively serve as first reference points SP4_0, SP4_1, SP4_2, and SP4_3. Besides, the processor 130 generates the at least one first support point on the first sliced object L1 according to the locations of the first reference points SP4_0, SP4_1, SP4_2, and SP4_3. The processor 130 enlarges the outer contour pattern C4 to form the second contour pattern C6. The three end points of the second contour pattern C6 may respectively serve as second reference points SP4_4, SP4_5, and SP4_6. Besides, the processor 130 generates the at least one second support point on the first sliced object L1 according to the locations of the second reference points SP4_4, SP4_5, and SP4_6.

In FIG. 5B, the first reference point SP4_0 of the first contour pattern C5 corresponds to the reference point SP3_0 of the outer contour pattern C3. The reference point SP4_1 of the first contour pattern C5 corresponds to the reference point SP3_1 of the outer contour pattern C3, and the rest may be deduced therefrom. In some embodiments, the processor 130 may move the reference points SP3_0, SP3_1, SP3_2, and SP3_3 toward any point within the contour pattern C3 (e.g., the center of gravity of the outer contour pattern C3), so as to respectively form the first reference points SP4_0, SP4_1, SP4_2, and SP4_3, whereby the first contour pattern C5 is formed. The processor 130 may also move the reference points SP3_4, SP3_5, and SP3_6 in a direction opposite to any point within the contour pattern C3 (e.g., the center of gravity of the contour pattern C3), so as to respectively form the second reference points SP4_4, SP4_5, and SP4_6, whereby the second contour pattern C6 is formed.

Next, in FIG. 5C, the first reference points SP4_0, SP4_1, SP4_2, and SP4_3 respectively replace the reference points SP3_0, SP3_1, SP3_2, and SP3_3. The second reference points SP4_4, SP4_5, and SP4_6 respectively replace the reference points SP3_4, SP3_5, and SP3_6. This causes the reference point of the first slice information L1 to include the first reference points SP4_0, SP4_1, SP4_2, and SP4_3 and the second reference points SP4_4, SP4_5, and SP4_6. The processor 130 determines the location of the at least one first support point on the first sliced object L1 according to the first reference points SP4_0-SP4_3 located in the first contour pattern C5 and determines the location of the at least one second support point on the first sliced object L1 according to the second reference points SP4_4-SP4_6 located in the second contour pattern C6. Hence, the at least one support point of the first sliced object L1 includes the at least one first support point and the at least one second support point.

As shown in FIG. 5C, the processor 130 further determines whether the distance between the adjacent support points is greater than the first predetermined distance, so as to determine whether to set an additional reference point or not. The implementation details of setting the additional reference point are sufficiently taught in the embodiment depicted in FIG. 4C and therefore will not be repeated hereinafter. In FIG. 5C, the reference points of the first slice information L1 not only include the first reference points SP4_0, SP4_1, SP4_2, and SP4_3 and the second reference points SP4_4, SP4_5, and SP4_6 but also include the additionally set reference points SP4_7-SP2_9 (the fifth reference point).

The processor 130 further determines whether an area of a second region surrounded by the first contour pattern C5 and the second contour pattern C6 in the first sliced object L1 is greater than a threshold area. If the processor 130 determines that the area of the second region is greater than the threshold area, the processor 130 determines a location of at least one fourth support point in the second region according to the supportable range of the at least one support element, wherein the location of the at least one fourth support point is evenly distributed in the second region. For instance, in FIG. 5C, the processor 130 determines that the area of the second region surrounded by the first contour pattern C5 and the second contour pattern C6 in the first sliced object L1 is less than or equal to the threshold area and therefore sets no additional support point.

The implementation details of determining that the area of the second region is greater than the threshold area are sufficiently taught in the embodiment depicted in FIG. 4D and therefore will not be repeated hereinafter.

With reference to the embodiments shown in FIG. 1 and FIG. 3, after the step S340_1 or S340_2 is completed, step S350 is performed. The processor 130 in step S350 may control the print head 120 to print the at least one support element (e.g., the support elements P1-P3) connected to the at least one support point on the platform 110 according to the location of the at least one support point.

In some embodiments, the processor 130 determines whether the distance (the fourth distance) between the adjacent support points is less than the second predetermined distance before step S350. If the distance between the adjacent support points is less than the second predetermined distance, the processor 130 in the step of printing the at least one support element connected to the at least one support point (step S350) merely controls the print head 120 to print the at least one support element (e.g., the support elements P1-P3) on the platform 110 according to a location of one of the adjacent support points. The second predetermined distance may be associated with a diameter of the at least one support element or the minimum size that can be printed by the 3D printing apparatus.

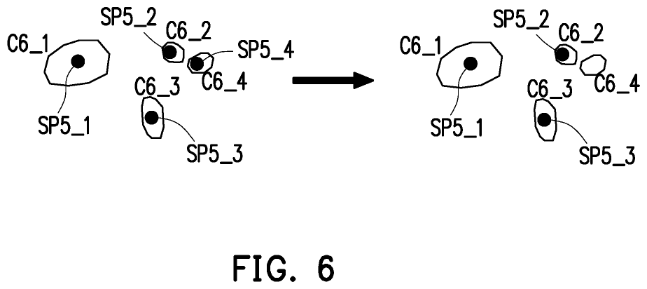

Specifically, please refer to FIG. 1 and FIG. 6. FIG. 6 is a schematic view of generating a support point according to still another embodiment provided in the disclosure. For instance, after the processor 130 determines the location of the at least one support point according to the reference points SP5_1-SP5_4 located in the contour patterns C6_1-C6_4, the processor 130 determines whether the distance (the fourth distance) between the adjacent support points (the fifth support point and the sixth support point) is less than the second predetermined distance according to the locations of the reference points SP5_1-SP5_4. If the processor 130 in FIG. 6 determines that the distance between the reference points SP5_2 and SP5_4 is less than the second predetermined distance, the processor 130 controls the print head 120 to print the at least one support element on the platform 110 merely according to the location of one of the adjacent support points (e.g., the location of the reference point SP5_2). Since the processor 130 does not utilize one of the overly close support points, material consumption of the at least one support element may be reduced.

To sum up, in one or more embodiments provided in the disclosure, the contour pattern corresponding to one of the sliced objects is acquired according to the slice information, the location of at least one support point on the sliced object is determined according to the reference points located in the contour pattern, and at least one support element connected to the at least one support point is printed on the platform according to the location of the at least one support point. Thereby, the overhanging portion of the 3D model may be supported by the at least one support element, so as to prevent the overhanging portion from collapsing. In addition, the location of the at least one support point is determined through enlarging or shrinking the contour pattern; thereby, after the printing action is completed, and in case that no support element exists at the end points or on the edge of the 3D model, the end points or the edge of the 3D model is not damaged during the removal of the at least one support element, and therefore the 3D model is not easily damaged.

Finally, it should be noted that each of the above embodiments is only used to describe the technical solution provided in the disclosure, not intended to limit the invention. Although the invention has been described in detail with reference to each of the foregoing embodiments, a person of ordinary skill in the art should understand that the technical solution recorded in each of the foregoing embodiments can be still modified or some or all of technical features can be equivalently replaced. These modifications or replacements do not make the essence of the corresponding technical solution depart from the scope of the technical solution in each embodiment provided in the disclosure.

What is claimed is:

1. A three-dimensional printing method suitable for a three-dimensional printing apparatus, the three-dimensional printing apparatus being configured to print a three-dimensional model on a platform, the three-dimensional printing method comprising:
acquiring a plurality of slice information corresponding to a plurality of sliced objects of the three-dimensional model, a direction of a normal vector of each of the plurality of sliced objects being the same as a direction of a normal vector of the platform, the plurality of sliced objects comprising a first sliced object, the plurality of slice information comprising first slice information corresponding to the first sliced object;
acquiring a contour pattern corresponding to the first sliced object according to the first slice information;
determining a plurality of reference points located in the contour pattern;
determining a location of at least one support point on the first sliced object according to the plurality of reference points located in the contour pattern; and
printing at least one support element connected to the at least one support point on the platform according to the location of the at least one support point, so that the three-dimensional model is supported by the at least one support element and fixed to the platform.

2. The three-dimensional printing method as recited in claim 1,
the contour pattern comprising a first contour pattern, the plurality of reference points comprising at least one first reference point, the at least one support point comprising at least one first support point,
the step of determining the plurality of reference points located in the contour pattern comprising:
acquiring an outer contour pattern corresponding to the first sliced object according to the first slice information;
shrinking the outer contour pattern to obtain the first contour pattern; and
determining the at least one first reference point located in the first contour pattern,
the step of determining the location of the at least one support point on the first sliced object according to the plurality of reference points located in the contour pattern comprising: determining a location of the at least one first support point on the first sliced object according to the at least one first reference point located in the first contour pattern.

3. The three-dimensional printing method as recited in claim 2,
the contour pattern comprising a second contour pattern, the plurality of reference points comprising at least one second reference point, the at least one support point comprising at least one second support point,
the step of determining the plurality of reference points located in the contour pattern further comprising:
acquiring an inner contour pattern corresponding to the first sliced object according to the first slice information, wherein a coverage of the outer contour pattern comprises the inner contour pattern;
enlarging the inner contour pattern to acquire the second contour pattern; and
determining the second reference point located in the second contour pattern,
the step of determining the location of the at least one support point on the first sliced object according to the plurality of reference points located in the contour pattern further comprising: determining a location of the at least one second support point on the first sliced object according to the at least one second reference point located in the second contour pattern.

4. The three-dimensional printing method as recited in claim 2, wherein the at least one support point comprises at least one third support point, and the step of determining the location of the at least one support point on the first sliced object according to the plurality of reference points located in the contour pattern comprises:
determining whether an area of a first region surrounded by the first contour pattern in the first sliced object is greater than a threshold area; and
if the area of the first region is greater than the threshold area, determining a location of the at least one third support point in the first region according to a supportable range of the at least one support element, wherein the location of the at least one third support point is evenly distributed in the first region.

5. The three-dimensional printing method as recited in claim 3, wherein the at least one support point comprises at least one fourth support point, and the step of determining the location of the at least one support point on the first sliced object according to the plurality of reference points located in the contour pattern comprises:
determining whether an area of a second region surrounded by the first contour pattern and the second contour pattern in the first sliced object is greater than a threshold area; and
if the area of the second region is greater than the threshold area, determining a location of the at least one fourth support point in the second region according to a supportable range of the at least one support element, wherein the location of the at least one fourth support point is evenly distributed in the second region.

6. The three-dimensional printing method as recited in claim 1, wherein the step of determining the plurality of reference points located in the contour pattern comprises:
determining whether a first distance between a third reference point and a fourth reference point of the plurality of reference points is greater than a first predetermined distance, wherein the third reference point is adjacent to the fourth reference point; and
if the first distance is greater than the first predetermined distance, a fifth reference point being set between the third reference point and the fourth reference point, so that a second distance between the third reference point and the fifth reference point is less than the first predetermined distance, and a third distance between the fourth reference point and the fifth reference point is less than the first predetermined distance.

7. The three-dimensional printing method as recited in claim 6, wherein the first predetermined distance associated with a radius of a supportable range of the at least one support element.

8. The three-dimensional printing method as recited in claim 1, before the step of printing the at least one support element connected to the at least one support point on the platform according to the location of the at least one support point, the method further comprising:
determining whether a fourth distance between a fifth support point and a sixth support point of the at least one support point is less than a second predetermined distance; and
if the fourth distance is less than the second predetermined distance, the step of printing the at least one support element connected to the at least one support point comprising printing the at least one support element on the platform according to a location of one of the fifth support point and the sixth support point.

9. A three-dimensional printing apparatus comprising:
a platform;
a print head configured to print a three-dimensional model on the platform; and
a processor configured to:
acquire a plurality of slice information corresponding to a plurality of sliced objects of the three-dimensional model, a direction of a normal vector of each of the plurality of sliced objects being the same as a direction of a normal vector of the platform, the plurality of sliced objects comprising a first sliced object, the plurality of slice information comprising first slice information corresponding to the first sliced object,
acquire a contour pattern corresponding to the first sliced object according to the first slice information and determine a plurality of reference points located in the contour pattern,
determine a location of at least one support point on the first sliced object according to the plurality of reference points located in the contour pattern, and
control the print head to print at least one support element connected to the at least one support point on the platform according to the location of the at least one support point, so that the three-dimensional model is supported by the at least one support element and fixed to the platform.

10. The three-dimensional printing apparatus as recited in claim 9,
the contour pattern comprising a first contour pattern, the plurality of reference points comprising at least one first reference point, the at least one support point comprising at least one first support point,
the processor being further configured to:
acquire an outer contour pattern corresponding to the first sliced object according to the first slice information,
shrink the outer contour pattern to obtain the first contour pattern, and
determine a location of the at least one first support point on the first sliced object according to the at least one first reference point located in the first contour pattern.

11. The three-dimensional printing apparatus as recited in claim 10,
the contour pattern comprising a second contour pattern, the plurality of reference points comprising at least one second reference point, the at least one support point comprising at least one second support point,
the processor being further configured to:
acquire an inner contour pattern corresponding to the first sliced object according to the first slice information, wherein a coverage of the outer contour pattern comprises the inner contour pattern,
enlarge the inner contour pattern to acquire the second contour pattern, determine the at least one second support point located in the second contour pattern, and
determine a location of the at least one second support point on the first sliced object according to the at least one second reference point located in the second contour pattern.

12. The three-dimensional printing apparatus as recited in claim 10, wherein the at least one support point comprises at least one third support point, and the processor is further configured to
determine whether an area of a first region surrounded by the first contour pattern in the first sliced object is greater than a threshold area, and
if the area of the first region is determined to be greater than the threshold area, determine a location of the at least one third support point in the first region according to a supportable range of the at least one support element, wherein the location of the at least one third support point is evenly distributed in the first region.

13. The three-dimensional printing apparatus as recited in claim 11, wherein the at least one support point comprises at least one fourth support point, and the processor is further configured to
determine whether an area of a second region surrounded by the first contour pattern and the second contour pattern in the first sliced object is greater than a threshold area, and
if the area of the second region is determined to be greater than the threshold area, determine a location of the at least one fourth support point in the second region according to a supportable range of the at least one support element, wherein the location of the at least one fourth support point is evenly distributed in the second region.

14. The three-dimensional printing apparatus as recited in claim 9, wherein the processor is further configured to:
determine whether a first distance between a third reference point and a fourth reference point of the plurality of reference points is greater than a first predetermined distance, wherein the third reference point is adjacent to the fourth reference point, and
if the first distance is greater than the first predetermined distance, set a fifth reference point between the third reference point and the fourth reference point, so that a second distance between the third reference point and the fifth reference point is less than the first predetermined distance, and a third distance between the fourth reference point and the fifth reference point is less than the first predetermined distance.

15. The three-dimensional printing apparatus as recited in claim 14, wherein the first predetermined distance associated with a radius of a supportable range of the at least one support element.

16. The three-dimensional printing apparatus as recited in claim 9, wherein the processor is further configured to:
determine whether a fourth distance between a fifth support point and a sixth support point of the at least one support point is less than a second predetermined distance, and
if the fourth distance is determined to be less than the second predetermined distance, the step of printing the at least one support element connected to the at least one support point comprises printing the at least one support element on the platform according to a location of one of the fifth support point and the sixth support point.
